(19) United States
(12) Patent Application Publication
(10) Pub. No.: US 2026/0065876 A1
(43) Pub. Date: Mar. 5, 2026

(54) FRAME RATE ADJUSTMENT METHOD, DEVICE, AND STORAGE MEDIUM

(71) Applicant: Beijing Zitiao Network Technology Co., Ltd., Beijing (CN)

(72) Inventors: Mingxuan LI, Beijing (CN); Guoxun ZHAO, Beijing (CN)

(21) Appl. No.: 19/316,557

(22) Filed: Sep. 2, 2025

(30) Foreign Application Priority Data
Sep. 2, 2024 (CN) 202411223791.4

(51) Int. Cl. G09G 5/00

(52) U.S. Cl. CPC G09G 5/006; G09G 2320/0261; G09G 2320/103; G09G 2340/0435; G09G 2340/16

(57) ABSTRACT

Embodiments of the present disclosure provide a frame rate adjustment method, a device, and a storage medium. And the method includes: in response to a trigger instruction for an object, obtaining an object type of the object, a resource file of the object, and/or a current power mode of the terminal device; determining a target display frame rate of the object according to the object type of the object, the resource file of the object, and/or the current power mode of the terminal device; and adjusting a current display frame rate of the object to a target display frame rate of the object according to a preset frame rate adjustment policy.

### CROSS-REFERENCE TO RELATED APPLICATION

The present application claims priority to Chinese Patent Application No. 202411223791.4, filed on Sep. 2, 2024, which is incorporated herein by reference in its entirety as a part of the present application.

### TECHNICAL FIELD

Embodiments of the present application relate to a frame rate adjustment method, a device, and a storage medium.

### BACKGROUND

With the popularity of terminal devices and the rapid development of technology, people can watch various image content, such as videos and animations, through terminal devices.

In related technologies, when the terminal device displays image content, it is necessary to adjust the display frame rate to improve the display smoothness of the image content to meet the image display requirements in different application scenarios. For example, to display scenes that require higher smoothness and visual effects, such as movies or live broadcasts, terminal devices usually need to use a higher display frame rate to display images to users, so that users can be provided with a smoother and more delicate visual experience; when displaying scenes that do not require high smoothness, such as static images, terminal devices can usually use a lower display frame rate to display images to users, thereby reducing power consumption and saving power resources.

Therefore, how to adjust the display frame rate of the terminal device according to the image display requirements in different application scenarios has become an urgent problem that needs to be solved.

### SUMMARY

Embodiments of the present disclosure provide a frame rate adjustment method, an apparatus, a device, a storage medium and a computer program product.

Embodiments of the present disclosure provide a frame rate adjustment method, applied to a terminal device, and the method includes:
in response to a trigger instruction for an object, obtaining an object type of the object, a resource file of the object, and/or a current power mode of the terminal device;
determining a target display frame rate of the object according to the object type of the object, the resource file of the object, and/or the current power mode of the terminal device; and
adjusting a current display frame rate of the object to a target display frame rate of the object according to a preset frame rate adjustment policy.

Embodiments of the present disclosure provide a frame rate adjustment apparatus, configured in a terminal device, including: an information acquisition module, a frame rate determination module, and a frame rate adjustment module.

The information acquisition module is configured to, in response to a trigger instruction for an object, obtain an object type of the object, a resource file of the object, and/or a current power mode of the terminal device.

The frame rate determination module is configured to determine a target display frame rate of the object according to the object type of the object, the resource file of the object, and/or the current power mode of the terminal device.

The frame rate adjustment module is configured to adjust a current display frame rate of the object to a target display frame rate of the object according to a preset frame rate adjustment policy.

Embodiments of the present disclosure provide an electronic device, including:

A processor and a memory, the memory is configured to store a computer program, and the processor is used to invoke and run the computer program stored in the memory to perform the frame rate adjustment method described in any embodiments of the present disclosure.

Embodiments of the present disclosure provide a computer-readable storage medium for storing a computer program that causes a computer to execute the frame rate adjustment method as described in the embodiments of the first aspect or their implementations.

Embodiments of the present disclosure provide a computer program product containing program instructions, which when the program instructions are run on an electronic device, cause the electronic device to execute the frame rate adjustment method as described in the embodiments of the first aspect or their implementations.

### BRIEF DESCRIPTION OF DRAWINGS

In order to explain the technical solutions in the embodiments of the present disclosure more clearly, the drawings needed to be used in the description of the embodiments will be briefly introduced below. Obviously, the drawings in the following description are only some embodiments of the present disclosure. For those of ordinary skill in the art, other drawings can be obtained based on these drawings without exerting creative efforts.

FIG. 1 is a schematic flowchart of a frame rate adjustment method provided by an embodiment of the present disclosure;

FIG. 2 is a schematic diagram of frame rate adjustment provided by an embodiment of the present disclosure;

FIG. 3 is a schematic flow chart for determining a target display frame rate provided by an embodiment of the present disclosure;

FIG. 4 is a schematic flowchart of another frame rate adjustment method provided by an embodiment of the present disclosure;

FIG. 5 is an overall schematic diagram of a terminal device displaying any image frame provided by an embodiment of the present disclosure;

FIG. 6 is a schematic block diagram of a frame rate adjustment apparatus provided by an embodiment of the present disclosure;

FIG. 7 is a schematic block diagram of an electronic device provided by an embodiment of the present disclosure.

### DETAILED DESCRIPTION

The technical solutions in the embodiments of the present disclosure will be clearly and completely described below with reference to the drawings in the embodiments of the present disclosure. Obviously, the described embodiments are only some of the embodiments of the present disclosure, not all of the embodiments. According to the embodiments in the present disclosure, all other embodiments obtained by those of ordinary skill in the art without creative efforts fall within the scope of protection of the present disclosure.

It should be noted that the terms “first”, “second”, etc. in the description and claims of the present disclosure and the above-mentioned drawings are used to distinguish similar objects and are not necessarily used to describe a specific order or sequence. It is to be understood that the data so used are interchangeable under appropriate circumstances such that the embodiments of the application described herein are capable of operation in sequences other than those illustrated or described herein. Furthermore, the terms “include” and “have” and any variations thereof, are intended to cover non-exclusive inclusions, e.g., a process, method, system, product or server that includes a series of steps or units need not be limited to those expressly listed steps or units, but may include other steps or units not expressly listed or inherent to such processes, methods, products or devices.

In the embodiments of the present disclosure, words such as “exemplary” or “such as” are used to mean examples, instances or illustrations. Any embodiment or scheme described as “exemplary” or “such as” in the embodiments of the present disclosure It should not be construed as preferred or advantageous over other embodiments or schemes. Rather, use of the words “exemplary” or “for example” is intended to present related concepts in a concrete fashion.

In order to facilitate understanding of the embodiments of the present disclosure, before describing each embodiment of the present disclosure, some concepts involved in all embodiments of the present disclosure are first appropriately explained, as follows:
1) Virtual Reality (VR), a technology for creating and experiencing virtual worlds, which computationally generates a virtual environment and is a type of multi-source information (Virtual Reality mentioned in the present disclosure at least includes visual perception, but also includes auditory perception, tactile perception, motion perception, and even taste perception, olfactory perception, etc.), realizing the simulation of fused, interactive three-dimensional dynamic vision and physical behavior of the virtual environment, immersing the user into the simulated Virtual Reality environment, and realizing applications in a variety of virtual environments such as maps, games, videos, education, medical care, simulation, collaborative training, sales, assisted manufacturing, maintenance and repair.
2) Virtual reality devices (VR devices), terminals that achieve virtual reality effects, can usually be provided in the form of glasses, head mount displays (Head Mount Display, HMD), and contact lenses for achieving visual perception and other forms of perception, of course, the form implemented by the virtual reality device is not limited to this, and can be further miniaturized or enlarged according to actual needs.

Optionally, the virtual reality devices described in the embodiments of the present disclosure may include but are not limited to the following types:
2.1) Computer-based virtual reality (PCVR) device uses the PC to perform related calculations and data output of virtual reality functions. External computer-based virtual reality device uses the data output by the PC to achieve the effect of virtual reality.
2.2) Mobile virtual reality device supports setting up mobile terminals (such as smartphones) in various ways (such as head-mounted displays with special card slots). Through wired or wireless connections with the mobile terminal, the mobile terminal performs calculations related to virtual reality functions and outputs data to mobile virtual reality devices, such as viewing virtual reality videos through the APP of the mobile terminal.
2.3) An all-in-one virtual reality device has a processor for performing calculations related to virtual functions. Therefore, it has independent virtual reality input and output functions. It does not need to be connected to a PC or mobile terminal, and has a high degree of freedom of use.
3) Augmented Reality (AR): A technology that calculates the camera pose parameters in the real world (or three-dimensional world, real world) in real time during the process of the camera collecting images, and adds virtual elements to the captured images based on the camera pose parameters. Virtual elements include, but are not limited to: images, videos, and three-dimensional models. The goal of AR technology is to interface the virtual world to the real world on the screen for interaction.
4) Mixed Reality (MR): A simulated set that integrates computer-created sensory input (e.g., virtual objects) with sensory input from a physical set or a representation thereof, in some MR sets, the computer-created sensory input can adapt to changes in sensory input from the physical set. Additionally, some electronic systems for presenting MR scenery may monitor orientation and/or position relative to the physical scenery to enable virtual objects to interact with real objects (ie, physical elements from the physical scenery or representations thereof). For example, the system may monitor motion so that the virtual plant appears stationary relative to the physical building.
5) Extended Reality (XR) refers to all real and virtual combined environments and frame rate adjustments generated by computer technology and wearable devices, which includes multiple forms of virtual reality (VR), augmented reality (AR), and mixed reality (MR).
6) A virtual scene (also called virtual space), which is a virtual scene displayed (or provided) by an application when running on an electronic device. The virtual scene can be a simulation environment for the real world, a semi-simulation and semi-fictional virtual scene, or a purely fictional virtual scene. The virtual scene can be any one of a two-dimensional virtual scene, a 2.5-dimensional virtual scene, or a three-dimensional virtual scene. In the embodiments of the present disclosure, the dimensions of the virtual scene are not limited. For example, the virtual scene can include sky, land, ocean, etc., and the land can include environmental elements such as deserts and cities.
7) Virtual objects (also called virtual objects), objects that interact in the virtual scene, objects that are under the control of a user or a robot program (e.g., an artificial intelligence-based robot program), capable of stationary, moving, and performing various behaviors in the virtual scene.

As mentioned above, when the terminal device displays image content, it is necessary to adjust the display frame rate to improve the display smoothness of the image content to meet the image display requirements in different application scenarios. For example, the terminal device can use a higher display frame rate to display screen content that requires higher display smoothness and visual effects to the user, such as movies or live videos; for scenes with low requirements for display smoothness, such as static images, the terminal device can display image content to the user by using a lower display frame rate, thereby reducing power consumption and saving power resources. However, how to adjust the display frame rate of the terminal device according to the image display requirements in different application scenarios has become an urgent problem that needs to be solved.

In response to the above technical problems, embodiments of the present disclosure provide a frame rate adjustment method, apparatus, device and storage medium to solve the problem of adjusting the display frame rate of the terminal device according to the image display requirements under different application scenarios.

The technical solutions provided by the embodiments of the present disclosure will be described in detail below through some embodiments. The embodiments described below can be combined with each other, and the same or similar concepts or processes may not be described again in some embodiments.

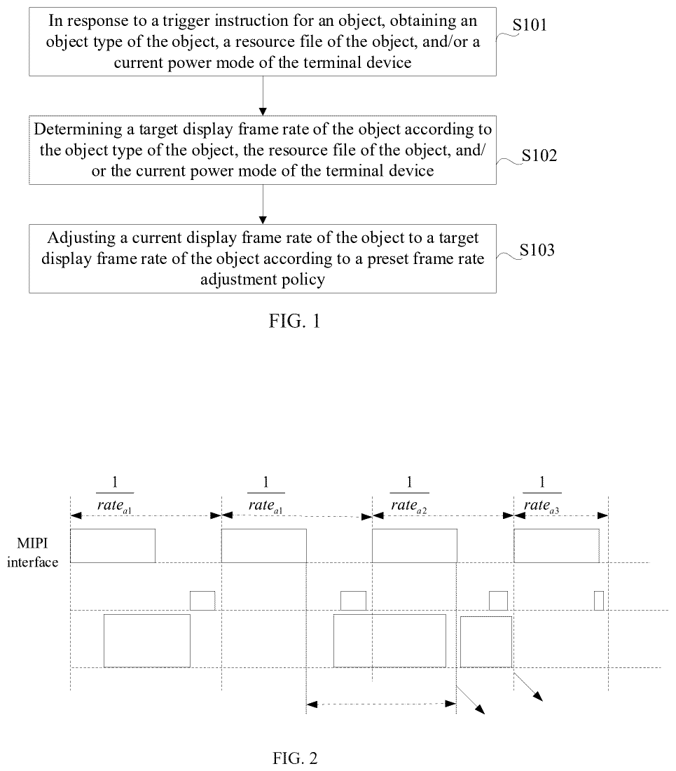

FIG. 1 is a schematic flowchart of a frame rate adjustment method provided by an embodiment of the present disclosure. The frame rate adjustment method provided by the present disclosure can be executed by a frame rate adjustment apparatus. The frame rate adjustment apparatus may be composed of hardware and/or software, and may be integrated into an electronic device provided with a screen and at least one Application (Application, app). In the embodiment of the present disclosure, the electronic device is optionally but not limited to: mobile phones, tablet computers, desktop/laptop computers, ultra-mobile personal computers (UMPC), handheld computers, netbooks, personal Digital Assistants (Personal Digital Assistants, PDAs), XR devices and other wearable devices. The present disclosure does not specifically limit the specific form of the electronic device. It should be understood that the above electronic device can be understood as a terminal device or User Equipment (UE).

As shown in FIG. 1, the method may include the following steps:

S101. in response to a trigger instruction for an object, obtaining an object type of the object, a resource file of the object, and/or a current power mode of the terminal device.

It should be understood that the above object is any application installed in the terminal device. That is, the object is an application.

The above object types can be understood as application types, such as video applications, game applications, shopping applications, etc. There is no restriction on the application types here.

The above resource files can be understood as resource data that needs to be displayed to the user during the operation of the object. And, the resource data file corresponds to the object. For example, when the object is a video application, the data file is a video resource; when the object is a game application, the data file is a game resource; when the object is a shopping application, the data file is a shopping resource, etc.

The above current power mode can be understood as the current power mode of the terminal device. In the present disclosure, the power mode of the terminal device may include but is not limited to: power saving mode and standard mode. Among them, the power saving mode refers to the use of the power saving mode to reduce the performance of the terminal device when the power of the terminal device is low, such as reducing the processor frequency, reducing the screen brightness, and turning off unnecessary functions, thereby reducing power consumption. The standard mode refers to the default power usage mode of the terminal device, through which the function is automatically adjusted according to the current usage of the electronic device to maintain the battery life and stability.

In some optional embodiments, when the user uses the terminal device, he or she can send a trigger instruction to any object in the terminal device, so that the terminal device starts and runs the object according to the trigger instruction for any object. The trigger instruction sent by the user can be sent by clicking the icon of any object on the screen of the terminal device, or can be sent by voice, etc. The present disclosure does not place any restrictions on the implementation method of the user sending the trigger instruction for any object.

When running the object, the present disclosure can obtain at least one of the object type of the object, the resource file of the object, and the current power mode of the terminal device, so that the object type of the object, the resource file of the object, and the current power mode of the terminal device can be obtained based on the obtained object type of the object, the resource file of the object, and the current power mode of the terminal device. At least one of the power modes is used to determine the target display frame rate of the object.

It should be understood that the target display frame rate refers to the display frame rate that the object is expected to achieve when running. Where the frame rate is shown, specifically the frame rate. Moreover, the frame rate (Frames Per Second, FPS) refers to the number of times the graphics processor (Graphics Processing Unit, GPU) refreshes the image per second.

In some optional embodiments, the present disclosure obtains the object type of the object, which may include but is not limited to the following methods:
Method 1: Obtain the main function information of the object, and determine the object type of the object based on the main function information.

For example, when the main function information of the object is to provide video functions to the user, then it can be determined that the object type of the object is a video object. For another example, when the main function of the object is to provide information such as news and industry trends to users, then the object type of the object can be determined to be a news information object, etc.
Method 2: Obtain the identification information of the object, and determine the object type of the object based on the identification information.

The identification information of the object may be the unique information of the object, such as the name of the object, etc., and there is no restriction on it here.

Optionally, the present disclosure can analyze whether the identification information of the object includes keywords that clearly point to a certain type or function. When included, the object type of the object can be determined based on type or function. When not included, the identification information of the object can be input into the search engine based on the identification information of the object to obtain the search results, and then the object type of the object can be determined by analyzing the description content in the search results or user evaluations.

In some optional embodiments, the present disclosure obtains the resource file of the object, which may include but is not limited to the following methods:

In the first way, considering that the installation package of the application can include various required files, such as configuration files, code files, and resource files, the present disclosure can obtain the resource file of the object from the installation package of the object.

In the second method, the resource file of the object can be obtained from the server based on the identification information of the object.

In some optional embodiments, when the present disclosure obtains the current power mode of the terminal device, it can obtain information such as the power, voltage and/or current of the battery through a power monitoring module or power monitoring system in the terminal device, and then determine the current power mode of the terminal device itself based on the obtained information such as power, voltage and/or current.

S102: determining a target display frame rate of the object according to the object type of the object, the resource file of the object, and/or the current power mode of the terminal device.

Optionally, when determining the target display frame rate of the object, it can be implemented based on at least one of the obtained object type of the object, the resource file of the object, and the current power mode of the terminal device.

In some optional embodiments, determining the target display frame rate of the object may include one of the following situations:
Case 1: According to the object type of the object, obtain the target display frame rate of the object from the mapping relationship between the object type and the display frame rate.
Case 2: According to the resource file of the object, obtain the target display frame rate of the object from the mapping relationship between the resource type and the display frame rate.
Case 3: According to the current power mode of the terminal device, obtain the target display frame rate of the object from the mapping relationship between the power mode and the display frame rate.
Case 4: According to the object type of the object, the resource file of the object, and the current power mode of the terminal device, obtain the target display frame rate of the object from the mapping relationship among the object type, resource type, power mode, and display frame rate.

It should be understood that the resource type of the above resource file can be determined according to the object type of the object. For example, when the object type of the object is a video object, then it can be determined that the resource type of the object's resource file is a video resource, etc. Or, the resource data in the resource file can also be analyzed and processed to obtain the resource type of the resource file, etc. Here, there is no restriction on determining the resource type of the resource file.

Moreover, the above-mentioned mapping relationship between object type and display frame rate, mapping relationship between resource type and display frame rate, mapping relationship between power mode and display frame rate, and mapping relationship between object type, resource type, power mode and display frame rate are all mapping relationship tables created in advance based on a large number of experiments. Moreover, each of the above mapping relationships can support update operations, which can meet the usage requirements of different application scenarios.

For example, assuming that the object type of the object is a video object, then the target display frame rate of the object can be determined to be 90 Hz from the mapping relationship between the object type and the display frame rate in Table 1 below.

TABLE 1

| Object Type | Display Frame Rate | |
|---|---|---|
| Reading Type | 60 | Hz |
| Video Type | 90 | Hz |
| Game Type | 120 | Hz |
| XX Type | 72 | Hz |

| | |
|---|---|
| . . . | . . . |

S103: adjusting a current display frame rate of the object to a target display frame rate of the object according to a preset frame rate adjustment policy.

In the present disclosure, the preset frame rate adjustment policy may be to adjust the display frame rate in a manner of successive increment or successive decrement according to the preset frame rate interval.

Among them, the preset frame rate interval can be selected to be 1 Hz. It should be understood that the preset frame rate interval can be set according to the situation where the human eye cannot easily perceive brightness changes, and there is no restriction on it here.

The above current display frame rate refers to the actual display frame rate when the object is running.

In some optional embodiments, it may first be determined whether the target display frame rate is greater than the current display frame rate. Afterwards, the current display frame rate of the object is adjusted based on the relationship between the target display frame rate and the current display frame rate.

Among them, adjusting the current display frame rate of the object according to the relationship between the target display frame rate and the current display frame rate may include the following situations:
Scenario 1: When the target display frame rate is greater than the current display frame rate, adjust the current display frame rate of the object in a successive increment manner according to the preset frame rate interval.
Scenario 2: When the target display frame rate is less than the current display frame rate, adjust the current display frame rate of the object in a successive decrement manner according to the preset frame rate interval.
Scenario 3: When the target display frame rate is equal to the current display frame rate, the display frame rate adjustment operation is not performed.

By using one of the above three situations to adjust the display frame rate, the present disclosure can not only dynamically adjust the display frame rate of the terminal device according to the application scenario, but also successive adjustment the display frame rate of the terminal device according to the preset frame rate interval. Display the frame rate, so that the display frame rate of the terminal device can be dynamically adjusted without the user's perception, thus making the adjustment of the display frame rate smoother and more natural.

For example, assume that before the user has not started the object, the display frame rate of the terminal device is 72 Hz. After the user starts the object, it is obtained that the object type of the object is a video object, and the target display frame rate of the object is determined to be 90 Hz based on the video object. Then, it can be determined that the target display frame rate of 90 Hz of the object is greater than the current display frame rate of 72 Hz of the object. At this time, the current display frame rate of the object can be adjusted in a successive increment manner according to the preset frame rate interval of 1 Hz according to the preset frame rate adjustment policy. 72 Hz is adjusted successively 18 times until the display frame rate of the object is 90 Hz.

Among them, the first adjustment is 72 Hz+1 Hz=73 Hz, the second adjustment is 73 Hz+1 Hz=74 Hz, and so on until the eighteenth adjustment is 89 Hz+1 Hz=90 Hz.

In some optional embodiments, considering that the object runs in the foreground of the terminal device, the image screen will be continuously displayed to the user through the screen of the terminal device. Therefore, when the present disclosure adjusts the current display frame rate of the object successively according to the preset frame rate adjustment policy and the target display frame rate, optionally, the Application Processor (AP) sequentially generates frame rate adjustment instructions and brightness adjustment instructions for controlling the screen backlight brightness according to the expected display frame rate to be adjusted. Then, the application processor AP sends the frame rate adjustment instruction and the brightness adjustment instruction to the display driver chip (Display Driver Integrated Circuit, DDIC) through the target interface, so that the display driver chip DDIC outputs the expected display frame rate carried by the frame rate adjustment instruction and the expected Pulse Width Modulation (PWM) signal carried by the brightness adjustment instruction to the screen during the display of the current image frame. This enables the screen to display the next image frame according to the expected display frame rate and control the screen backlight brightness according to the expected PWM signal when displaying the next image frame. That is, the adjustment of the display frame rate of the terminal device and the screen backlight PWM signal needs to maintain a certain timing, so that the consistency of the screen backlight brightness adjustment timestamp and the display frame rate adjustment timestamp can be ensured, as shown in FIG. 2.

In the present disclosure, the above target interface may be a Mobile Industry Processor Interface (MIPI).

The expected display frame rate may be understood as the display frame rate obtained by increasing the current display frame rate of the object or the adjusted current display frame rate by a preset frame rate interval. The expected PWM signal can be understood as a PWM signal of a corresponding width (duty cycle) obtained according to the expected display frame rate. That is, a PWM signal with a corresponding duty cycle can be calculated based on each expected display frame rate.

Moreover, when the application processor AP of the present disclosure transmits the frame rate adjustment instruction and the brightness adjustment instruction through the MIPI interface, it can be executed after the MIPI interface transmits the current image frame and before the transmission of the next image frame is completed, so that the adjusted current display frame rate and screen backlight PWM signal can be effective when the next image frame located after the current image frame is displayed.

In some optional embodiments, considering that the present disclosure adjusts the display frame rate of the terminal device, it takes effect when the next image frame is displayed. Therefore, after each adjustment of the current display frame rate of the object according to the preset frame rate adjustment policy and the target display frame rate, optionally, the present disclosure can display a first image frame according to the current display frame rate after each adjustment when a current display frame rate after each adjustment is in an effective time, where the first image frame is a frame of image data in the resource file of the object.

The first image frame can be understood as the next image frame after the current image frame in which the object is displayed.

The technical solution disclosed in the embodiment of the present disclosure obtains the object type of the object, the resource file of the object, and/or the current power mode of the terminal device by responding to the trigger instruction for the object, so as to determine the target display frame rate of the object according to the object type of the object, the resource file of the object, and/or the current power mode of the terminal device, and then adjust the current display frame rate of the object to the target display frame rate of the object according to the preset frame rate adjustment policy. In this way, the display frame rate of the terminal device can be dynamically adjusted without the user's perception according to the image display requirements under different application scenarios, thereby improving the user experience.

Based on the foregoing embodiments, it is considered that when the user uses the terminal device, the object running in the foreground of the terminal device may be switched, such as switching from the first object to the second object, where the first object is the object running in the foreground of the terminal device (i.e. the current object), and the second object is the new object to be switched. Since the second object may be of a different type from the current object, or the power mode of the terminal device may change when running the second object, the present disclosure may also include: in response to a switching instruction to switch the object to another object, obtaining the target display frame rate of the other object; according to the preset frame rate adjustment policy, the current display frame rate of other objects is adjusted successively to the target display frame rate of other objects. In the present disclosure, other objects can be understood as second objects that are different from the current object.

Among them, the implementation principle of obtaining the target display frame rate of other objects and adjusting the current display frame rate of other objects is the same or similar to the aforementioned implementation method of obtaining the target display frame rate of the object and adjusting the current display frame rate of the object. For details, please refer to the previous embodiments, which will not be described in detail here.

That is, the present disclosure can obtain the target display frame rate of the object based on the object running in the foreground of the terminal device, and then dynamically adjust the current display frame rate of the object based on the target display frame rate.

It should be understood that the present disclosure dynamically adjusts the current display frame rate of the object running in the foreground of the terminal device, which may refer to dynamically adjusting the current display frame rate of the terminal device.

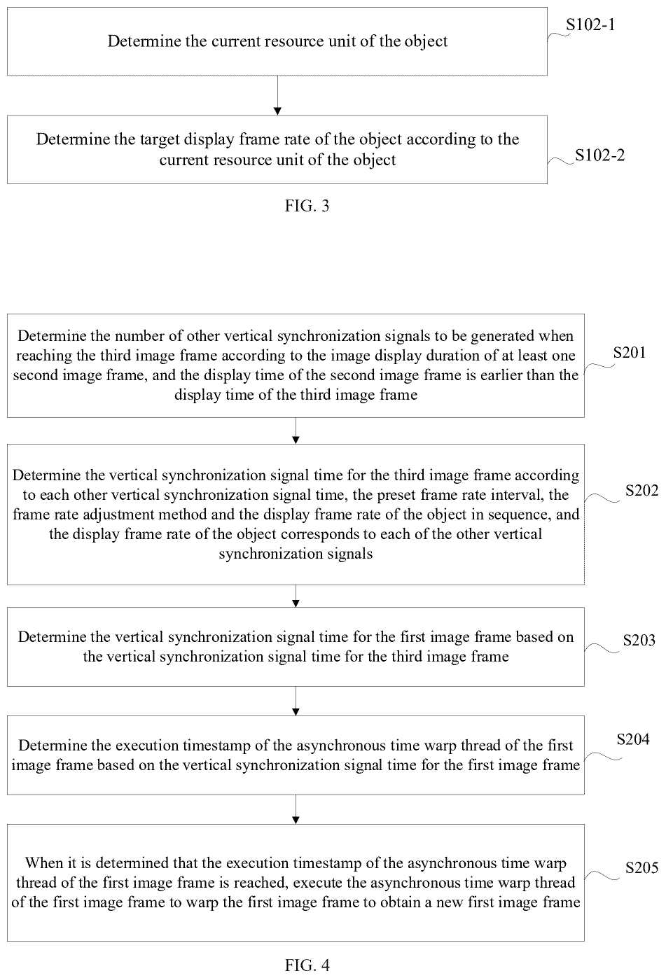

In some optional implementations, it is considered that the resource file of any object in the terminal device may include multiple resource units with different resource types. For example, the resource file of a live application includes live main content and live transition content. Moreover, the image content display requirements of different resource units may also be different. For example, live main content requires a lower display frame rate of 36 Hz, while live transition content requires a higher display frame rate of 72 Hz, etc. Therefore, the present disclosure can also determine the target display frame rate of the object based on the current resource unit of the object. The following further explains the determination of the target display frame rate of the object based on the resource file of the object in the above embodiment with reference to FIG. 3.

As shown in FIG. 3, the above step S102 may include the following steps S102-1 to S102-2:

S102-1: Determine the current resource unit of the object.

In some optional embodiments, the current display of the object can be determined by analyzing the timeline, progress bar, chapter information of the image frame displayed by the object to the user, and changes in the content of multiple consecutive frames of images, such as color changes or shape changes, which resource unit in its own resource file the currently displayed image frame of the object belongs to.

For example, when the object is a video object, then it can be determined whether the current image content displayed by the object to the user belongs to video main content or video transition content. When it is determined that the current image content belongs to video main content, it can be determined that the current resource unit of the object is a video text unit.

S102-2: Determine the target display frame rate of the object according to the current resource unit of the object.

In some optional embodiments, the present disclosure can obtain the target display frame rate of the object from the mapping relationship between the resource unit and the display frame rate according to the current resource unit of the object.

That is, when the present disclosure determines the target display frame rate of the object based on the resource file of the object, it can also be refined to determine which resource unit the object is currently displaying to the user, and then according to the resource unit, determine the corresponding target display frame rate from the pre-constructed resource unit and display frame rate mapping relationship, so that the display frame rate of the terminal device can be dynamically adjusted according to the image content displayed in real time by the object, thereby enabling the automatic adjustment of the terminal device's display frame rate in any scenario where display frame rate adjustment is needed. Automatically adjusts the display frame rate of the terminal device, and this automatically adjusted display frame rate is always imperceptible to the user, thereby improving the user experience.

In some optional embodiments, it is considered that when the display frame rate of the terminal device is dynamically adjusted, frame loss may occur, resulting in discontinuous, stuck or delayed image display. Because when the terminal device runs any object, the object will display at least one frame of image at the display frame rate before it was run. Therefore, before adjusting the display frame rate of the terminal device, the present disclosure can determine the timing suitable for adjusting the display frame rate based on at least one frame of image displayed by the object at the display frame rate before it was not running, and then start the frame rate display adjustment operation. In this way, the frame loss phenomenon that occurs when adjusting the display frame rate of the terminal device can be avoided. The frame rate adjustment method provided by the embodiment of the present disclosure will be further explained below with reference to FIG. 4.

As shown in FIG. 4, the method may include the following steps:

S201: Determine the number of other vertical synchronization signals to be generated when reaching the third image frame according to the image display duration of at least one second image frame, and the display time of the second image frame is earlier than the display time of the third image frame.

The second image frame refers to an image frame located before the third image frame and belonging to the same object as the third image frame.

In the present disclosure, when the third image frame is the current image frame, the at least one second image frame includes at least one historical image frame located before the current image frame.

Moreover, the above image display duration can be understood as image drawing time (Motion-To-Photon, MTP).

It should be understood that the above image drawing time MTP refers to the entire time it takes for the user to start moving until the image changes, and the changed image is displayed to the user through the terminal device.

In some optional embodiments, the present disclosure can obtain the image display duration of each second image frame, and then use the phase synchronization signal (phaseSync) to calculate the number of vertical synchronization signals (VSync) to be crossed when reaching the third image frame based on the image display duration of all second image frames. The vertical synchronization signals to be crossed here are the other vertical synchronization signals mentioned above.

As an optional implementation method, the above-mentioned use of the phase synchronization signal (phaseSync) to calculate the vertical synchronization signal to be crossed when reaching the third image frame based on the image display duration of all second image frames may include the following steps:

Step 11: Obtain the display refresh rate of the terminal device.

Step 12: Calculate the interval of the vertical synchronization signal based on the display refresh rate of the terminal device.

For example, when the display refresh rate of the terminal device is 72 Hz, then according to 1/72=13.89 ms, the interval of the vertical synchronization signal can be determined to be 13.89 milliseconds.

Step 13: Determine the image display duration of the third image frame.

The image display duration of the above-mentioned third image frame refers to the image display duration of the image frame that is currently being rendered or has been rendered and prepared for display.

Step 14: Calculate the time difference between the last recorded historical image frame MTP and the third image frame MTP.

Step 15: Divide the time difference calculated in step 14 by the interval of the vertical synchronization signal calculated in step 12 to obtain the calculation result.

Because the vertical synchronization signals are discrete, the present disclosure can round up the calculation result in step 15, and use the rounded value as the number of crossed vertical synchronization signals.

S202, determine the vertical synchronization signal time for the third image frame according to each other vertical synchronization signal time, the preset frame rate interval, the frame rate adjustment method and the display frame rate of the object in sequence, and the display frame rate of the object corresponds to each of the other vertical synchronization signals.

In the present disclosure, the vertical synchronization signal time can be understood as the time when the vertical synchronization signal is generated.

Among them, the display frame rate of the above object (the display frame rate of the terminal device) corresponds to each of the other vertical synchronization signals. It can be understood that each of the other vertical synchronization signals will correspond to a display frame rate, and adjacent display frame rates may be the same It may also be different.

Optionally, when it is determined that the display frame rate needs to be adjusted, the above-mentioned adjacent display frame rates are different. When it is determined that there is no need to adjust the display frame rate, the adjacent display frame rates are the same.

Considering that the display screen refresh rate of the terminal device can be obtained, the present disclosure can calculate the time of each of the other vertical synchronization signals based on the display screen refresh rate of the terminal device and the number of other vertical synchronization signals to be generated.

Therefore, when it is determined that the display frame rate needs to be adjusted, the present disclosure does not directly adjust the display frame rate, but first, in advance, determines the vertical synchronization signal time for the third image frame according to the number of other vertical synchronization signals to be generated when the third image frame is reached, and according to the generation time corresponding to each of the other vertical synchronization signals, the preset frame rate interval, the frame rate adjustment method, and the display frame rate of the object. After that, when the vertical synchronization signal time for the third image frame reaches, the display frame rate adjustment operation is performed again.

For the specific process of performing the display frame rate adjustment operation, please refer to the aforementioned embodiments, and it will not be described in detail here.

In some optional embodiments, the vertical synchronization signal time for the third image frame can be determined according to the following formula (1), sequentially according to each other vertical synchronization signal time, preset frame rate interval, frame rate adjustment method, and display frame rate of the object. Vertical synchronization signal time:

$${predictV}_{i} = {nowV}_{i - 1} + \frac{1}{{rate}_{i - 1} + gradient * trend} \qquad ( 1 )$$

Among them, predict Vᵢ is the vertical synchronization signal time of the i-th image frame, i is ater than 1 and less than or equal to j, where j is the position information corresponding to the third image frame, now Vᵢ₋₁ is the vertical synchronization signal time of the i−1th image frame, rateᵢ₋₁ is the display frame rate corresponding to the i−1th image frame, is the preset gradient frame rate interval, and trend is the frame rate adjustment trend value, where when the display frame rate is adjusted from a small display frame rate to a large display frame rate, trend it is taken to be −1; when the display frame rate is adjusted from a large display frame rate to a small display frame rate, the trend value takes 0.

For example, when the current display frame rate of the terminal device is 72 Hz and the target display frame rate is 90 Hz, this means that the display frame rate of the terminal device is adjusted from a small display frame rate of 72 Hz to a large display frame rate of 90 Hz, then the trend value takes −1.

S203: Determine the vertical synchronization signal time for the first image frame based on the vertical synchronization signal time for the third image frame.

Since the target display frame rate has been determined when adjusting the display frame rate, the present disclosure can use the formula (1) in the aforementioned step S202 to determine the vertical synchronization signal time for the first image frame based on the vertical synchronization signal time of the third image frame.

Among them, in formula (1), predictVᵢ is the vertical synchronization signal time for the first image frame, and nowVᵢ₋₁ is the vertical synchronization signal time for the third image frame.

S204: Determine the execution timestamp of the asynchronous time warp thread of the first image frame based on the vertical synchronization signal time for the first image frame.

S205: When it is determined that the execution timestamp of the asynchronous time warp thread of the first image frame is reached, execute the asynchronous time warp thread of the first image frame to warp the first image frame to obtain a new first image frame.

In the present disclosure, the execution timestamp of the Asynchronous Time Warp (ATW) thread of the first image frame can be understood as the start working duration stamp of the Asynchronous Time Warp thread of the first image frame.

In some optional embodiments, the execution timestamp of the Asynchronous Time Warp thread (ATW) of the first image frame can be determined by the following steps:

Step 21: Obtain the first working duration of the asynchronous time warp thread for each second image frame, and the second working duration of the asynchronous time warp thread for the third image frame.

In the present disclosure, a timer or the like may be used to count the first working duration of the asynchronous time warp thread for each second image frame and the second working duration of the asynchronous time warp thread for the third image frame when the asynchronous time warp thread processes each second image frame and the third image frame.

Step 22: Determine the average and variance values of the working duration based on at least one first working duration and the second working duration.

Step 23: Determine the working duration of the asynchronous time warp thread for the first image frame based on the average and variance values of the working duration.

In some embodiments, determining the working duration of the asynchronous time warp thread for the first image frame can be implemented by the following formula (2):

$${T}_{n} = {T}_{ave} + {T}_{var} * α \qquad ( 2 )$$

Where Tₙ is the working duration of the asynchronous time warp thread for the first image frame, Tₐᵥₑ is the average of the working duration, Tᵥₐᵣ is the variance of the working duration, and α is an adjustable parameter.

Step 24: Determine the execution timestamp of the asynchronous time warp thread for the first image frame based on the vertical synchronization signal time for the first image frame and the working duration of the asynchronous time warp thread for the first image frame.

Consider that each image frame will correspond to at least one vertical synchronization signal, and each vertical synchronization signal will correspond to a MIPI interface (ie, the target interface), and the reading interval of each vertical synchronization signal and the corresponding MIPI interface is fixed. The interval of the vertical synchronization signal is calculated based on one divided by the refresh rate of the display.

Also because the vertical synchronization signal and the MIPI interface differ by a preset time interval Δt. Among them, the preset time interval Δt is a fixed value. Then, after obtaining the working duration of the asynchronous time warp thread of the first image frame, the present disclosure can first determine the execution timestamp of the target interface based on the vertical synchronization signal of the first image frame and the preset time interval. Next, an execution timestamp of the asynchronous time warp thread for the first image frame is determined from the execution timestamp of the target interface and the working duration of the asynchronous time warp thread for the first image frame.

In some embodiments, the execution timestamp of the target interface is determined based on the vertical synchronization signal of the first image frame and the preset time interval Δt, which may be based on the vertical synchronization signal time for the first image frame plus the preset time interval, and the sum value is used as the start working duration of the MIPI interface.

In some embodiments, determining the execution timestamp of the asynchronous time warp thread for the first image frame based on the execution timestamp of the target interface and the working duration of the asynchronous time warp thread for the first image frame may be obtained by subtracting the working duration of the asynchronous time warp thread for the first image frame from the start working duration of the MIPI interface.

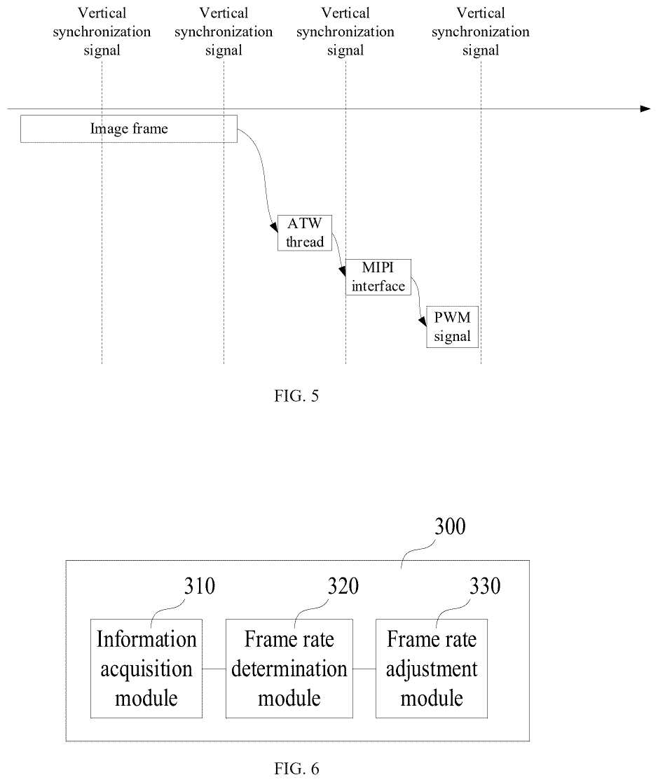

Furthermore, when it is determined that the current time reaches the execution timestamp of the asynchronous time warp thread of the first image frame, the present disclosure can execute the asynchronous time warp thread of the first image frame to warp the already rendered first image frame to obtain a new first image frame. In this way, the start time point of the asynchronous time warp thread can be accurately predicted, thereby avoiding frame loss that occurs when adjusting the display frame rate of the terminal device. As shown in FIG. 5, it is an overall schematic diagram of the terminal device displaying any image frame.

In some optional embodiments, since the execution timestamp of the target interface has been obtained in the foregoing description, the asynchronous time warp thread of the first image frame warps the first image frame to generate a new first image frame, and When the execution timestamp of the target interface is reached, the present disclosure can control the target interface to transmit the new first image frame to the screen of the terminal device, so that the screen displays the new first image frame. In this way, the conflict problem between when the image frame is written into the single buffer and when the screen MIPI interface reads the image frame from the single buffer can be solved, thereby avoiding the problem of screen tearing.

Considering that when the screen display MIPI interface of the terminal device reads the image frame, the working duration of the PWM signal that controls the screen backlight brightness may not be accurately predicted. In this regard, the present disclosure can determine the predicted display duration of the object based on the display frame rate of the object and the expected display frame rate of the object. Among them, the display frame rate of the object is the current display frame rate or the current display frame rate after each adjustment; the expected display frame rate may be understood as a display frame rate obtained by adding a preset frame rate interval to the current display frame rate of the object or the adjusted current display frame rate.

Furthermore, based on the predicted display duration of the object, the execution timestamp of the target pulse modulation signal for lighting the screen is determined. And, when the execution timestamp of the target pulse modulation signal is reached, the screen backlight is lit according to the target pulse modulation signal, and a new first image frame is displayed through the screen.

In some optional embodiments, the above-mentioned determination of the predicted display duration of the object based on the display frame rate of the object and the expected display frame rate of the object can be implemented by the following formula (3):

$${t}_{Y} = \frac{\frac{1}{p} + \frac{1}{q}}{2} \qquad ( 3 )$$

Among them, t_{Y} is the predicted display duration of the object, p is the display frame rate of the object, and q is the expected display frame rate of the object.

In some embodiments, the execution timestamp of the target pulse modulation signal for lighting the screen is determined based on the predicted display duration of the object, and the predicted display duration of the object can be used as the time period. Whenever the time is a new time period, it is determined that the current time reaches the execution timestamp of the target pulse modulation signal. At this time, the screen backlight circuit lights the screen backlight according to the target pulse modulation signal, and uses the lit screen to display a new first image frame. In this way, the working time point of the PWM signal that controls the brightness of the screen backlight can be accurately predicted, and then the screen can be accurately lit to display image frames with the adjusted current display frame rate.

In the present disclosure, the above-mentioned target pulse modulation signal refers to the expected pulse width modulation signal carried by the brightness adjustment instruction in the aforementioned embodiment.

That is to say, when the present disclosure adjusts the current display frame rate of the terminal device according to the target display frame rate, on the one hand, it can dynamically adjust the display frame rate of the terminal device according to the image display requirements in different application scenarios without the user's perception. rate, on the other hand can also avoid the problems of frame loss, screen tearing, and inaccurate screen backlight lighting time caused by display frame rate adjustment, thereby further improving the user experience.

A frame rate adjustment apparatus proposed by an embodiment of the present disclosure will be described below with reference to FIG. 6. FIG. 6 is a schematic block diagram of a frame rate adjustment apparatus provided by an embodiment of the present disclosure. Among them, the frame rate adjustment apparatus proposed in the present disclosure is configured in the terminal device.

As shown in FIG. 6, the frame rate adjustment apparatus 300 includes: an information acquisition module 310, a frame rate determination module 320 and a frame rate adjustment module 330.

The information acquisition module 310 is configured to, in response to a trigger instruction for an object, obtain an object type of the object, a resource file of the object, and/or a current power mode of the terminal device.

The frame rate determination module 320 is configured to determine a target display frame rate of the object according to the object type of the object, the resource file of the object, and/or the current power mode of the terminal device.

The frame rate adjustment module 330 is configured to adjust a current display frame rate of the object to a target display frame rate of the object according to a preset frame rate adjustment policy.

In one or more optional implementations of the embodiment of the present disclosure, the frame rate adjustment apparatus 300 also includes: a display module.

The display module is configured to, when a current display frame rate after each adjustment is in an effective time, display a first image frame according to the current display frame rate after each adjustment, where the first image frame is a frame of image data in the resource file of the object.

In one or more optional implementations of the embodiments of the present disclosure, the preset frame rate adjustment policy is to adjust the display frame rate in a manner of successive increment or successive decrement according to a preset frame rate interval.

In one or more optional implementations of the embodiment of the present disclosure, the resource file of the object includes at least two resource units, and a resource type of each resource unit is different;

Correspondingly, the frame rate determination module 320 includes:

The first determination unit is configured to determine a current resource unit of the object;

The second determination unit is configured to determine the target display frame rate of the object according to the current resource unit of the object.

In one or more optional implementations of the embodiment of the present disclosure, the second determination unit is specifically configured to obtain the target display frame rate of the object from a mapping relationship between a resource unit and a display frame rate according to the current resource unit of the object.

In one or more optional implementations of the embodiment of the present disclosure, the frame rate determination module 320 is specifically configured to obtain the target display frame rate of the object from a mapping relationship between the object type and a display frame rate according to the object type of the object; or, obtain the target display frame rate of the object from a mapping relationship between a resource type and the display frame rate according to the resource file of the object; or, obtain the target display frame rate of the object from a mapping relationship between a power mode and the display frame rate according to the current power mode of the terminal device; or, obtain the target display frame rate of the object from a mapping relationship among the object type, the resource type, the power mode, and display frame rate, according to the object type of the object, the resource file of the object, and the current power mode of the terminal device.

In one or more optional implementations of the embodiment of the present disclosure, the frame rate adjustment apparatus 300 also includes:

A first determination module is configured to determine a number of other vertical synchronization signals to be generated when reaching a third image frame according to an image display duration of at least one second image frame, where a display time of the second image frame is earlier than a display time of the third image frame.

A second determination module is configured to determine a vertical synchronization signal time for the third image frame according to each other vertical synchronization signal time, the preset frame rate interval, a frame rate adjustment method and a display frame rate of the object in sequence, the display frame rate of the object corresponds to each of the other vertical synchronization signals.

In one or more optional implementations of the embodiment of the present disclosure, the frame rate adjustment apparatus 300 also includes:

A third determination module is configured to determine a vertical synchronization signal time for the first image frame according to the vertical synchronization signal time for the third image frame.

A fourth determination module is configured to determine an execution timestamp for an asynchronous time warp thread for the first image frame according to the vertical synchronization signal time for the first image frame;

A first processing module is configured to, when it is determined that the execution timestamp of the asynchronous time warp thread for the first image frame is reached, execute the asynchronous time warp thread for the first image frame to warp the first image frame to obtain a new first image frame.

In one or more optional implementations of the embodiment of the present disclosure, the fourth determination module is specifically configured to obtain a first working duration of an asynchronous time warp thread for each second image frame and a second working duration of an asynchronous time warp thread for the third image frame; determine an average value and a variance value of working durations according to the at least one first working duration and the second working duration; determine a working duration of the asynchronous time warp thread for the first image frame according to the average value and the variance value of the working duration; and determine the execution timestamp for the asynchronous time warp thread for the first image frame according to the vertical synchronization signal time for the first image frame and the working duration of the asynchronous time warp thread for the first image frame.

In one or more optional implementations of the embodiment of the present disclosure, the frame rate adjustment apparatus 300 also includes:

A fifth determination module is configured to determine an execution timestamp of a target interface according to the vertical synchronization signal time for the first image frame and a preset time interval.

A second processing module is configured to, when it is determined that the execution timestamp of the target interface is reached, control the target interface to transmit the new first image frame to a screen of the terminal device for a display operation.

In one or more optional implementations of the embodiment of the present disclosure, the frame rate adjustment apparatus 300 also includes:

A sixth determination module is configured to determine a predicted display duration of the object according to the display frame rate of the object and an expected display frame rate of the object, the display frame rate is the current display frame rate or a current display frame rate after each adjustment.

A seventh determination module is configured to determine an execution timestamp of a target pulse modulation signal for lighting a screen according to the predicted display duration of the object.

A third processing module is configured to, when the execution timestamp of the target pulse modulation signal is reached, light the screen backlight according to the target pulse modulation signal, and display the new first image frame through the screen.

It should be understood that the device embodiments and the aforementioned method embodiments may correspond to each other, and similar descriptions may refer to the method embodiments. To avoid duplication, it will not be repeated here. Specifically, the apparatus 300 shown in FIG. 6 can execute the method embodiment corresponding to FIG. 1, and the foregoing and other operations and/or functions of each module in the apparatus 300 are respectively intended to implement the corresponding processes in each method in FIG. 1. For simplicity, details will not be repeated here.

The apparatus 300 according to the embodiment of the present disclosure is described above from the perspective of functional modules in conjunction with the accompanying drawings. It should be understood that the functional modules can be implemented in hardware or software, or a combination of hardware and software modules. Specifically, each step of the first aspect method in the embodiment of the present disclosure can be completed by instructions in the form of hardware integrated logic circuits and/or software in the processor, combined with the steps of the first aspect method disclosed in the embodiment of the present disclosure, it can be directly embodied as a hardware decoding processor for execution, or by a combination of hardware and software modules in the decoding processor. Optionally, the software module may be located in random access memory, flash memory, read-only memory, programmable read-only memory, electrically erasable programmable memory, register and other mature storage media in the art. The storage medium is located in the memory, and the processor reads the information in the memory and completes the steps in the above method embodiment of the first aspect in combination with its hardware.

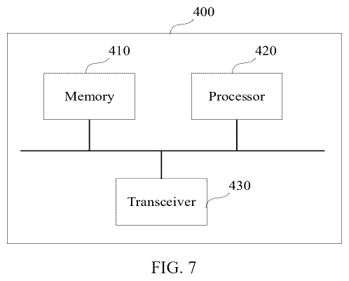

FIG. 7 is a schematic block diagram of an electronic device provided by an embodiment of the present disclosure. As shown in FIG. 7, the electronic device 400 may include:

Memory 410 and processor 420, the memory 410 is used to store computer programs and transmit the program codes to the processor 420. In other words, the processor 420 can invoke and run a computer program from the memory 410 to implement the frame rate adjustment method in the embodiment of the present disclosure.

For example, the processor 420 may be configured to execute the above frame rate adjustment method embodiments according to instructions in the computer program.

In some embodiments of the present disclosure, the processor 420 may include but is not limited to:

A general-purpose processor, a Digital Signal Processor (DSP), an Application Specific Integrated Circuit (ASIC), a Field Programmable Gate Array (FPGA) or other programmable logic device, discrete gate or transistor logic, discrete hardware components, and the like.

In some embodiments of the present disclosure, the memory 410 includes but is not limited to:

Volatile memory and/or non-volatile memory. Among them, the non-volatile memory can be Read-Only Memory (Read-Only Memory, ROM), programmable Read-Only Memory (Programmable ROM, PROM), erasable programmable Read-Only Memory (Erasable PROM, EPROM), electrically erasable memory Except programmable Read-Only Memory (Electrically EPROM, EEPROM) or flash memory. Volatile memory may be Random Access Memory (RAM), which acts as an external cache. By way of illustration and not limitation, many forms of RAM are available such as Static RAM (SRAM), Dynamic RAM (DRAM), Synchronous DRAM (SDRAM), Double Data Rate SDRAM (DDR SDRAM), Enhanced synchronous dynamic random access memory (ESDRAM), synch link DRAM (SLDRAM), and Direct Rambus RAM (DR RAM).

In some embodiments of the present disclosure, the computer program can be divided into one or more modules, and the one or more modules are stored in the memory 410 and executed by the processor 420 to complete the frame provided by the present disclosure Rate adjustment method. The one or more modules may be a series of computer program instruction segments that can complete specific functions, and the instruction segments are used to describe the execution process of the computer program in the electronic device.

As shown in FIG. 7, the electronic device 400 may also include:

A transceiver 430, which may be connected to the processor 420 or the memory 410.

The processor 420 can control the transceiver 430 to communicate with other devices. Specifically, it can send information or data to other devices or receive information or data sent by other devices. The transceiver 430 may include a transmitter and a receiver. The transceiver 430 may further include antennas, and the number of antennas may be one or more.

It should be understood that various components in the electronic device are connected through a bus system, where in addition to the data bus, the bus system also includes a power bus, a control bus and a status signal bus.

The present disclosure also provides a computer storage medium on which a computer program is stored. When the computer program is executed by a computer, the computer can execute the frame rate adjustment method of the above method embodiment.

Embodiments of the present disclosure also provide a computer program product including program instructions. When the program instructions are run on an electronic device, causes the electronic device to execute the frame rate adjustment method of the above method embodiment.

When implemented using software, it may be implemented in whole or in part in the form of a computer program product. The computer program product includes one or more computer instructions. When the computer program instructions are loaded and executed on a computer, the processes or functions according to the embodiments of the present disclosure are produced in whole or in part. The computer may be a general-purpose computer, special purpose computer, computer network, or other programmable apparatus. The computer instructions may be stored on a computer-readable storage medium, or transmitted from one computer-readable storage medium to another computer-readable storage medium. For example, the computer instructions may be transmitted from one website, computer, server, or data center via Wired (such as coaxial cable, optical fiber, digital subscriber line (DSL)) or wireless (such as infrared, wireless, microwave, etc.) means to another website site, computer, server, or data center. The computer-readable storage medium can be any available medium that can be accessed by a computer or a data storage device such as a server or data center integrated with one or more available media. The available medium may be a magnetic medium (e.g., floppy disk, hard disk, tape), an optical medium (e.g., digital video disc (DVD)), or a semiconductor medium (e.g., solid state disk (SSD)), etc.

Those of ordinary skill in the art can appreciate that the modules and algorithm steps of each example described in conjunction with the embodiments disclosed herein can be implemented in electronic hardware, or a combination of computer software and electronic hardware. Whether such functions are implemented as hardware or software depends upon the particular application and design constraints imposed by the solution. Skilled artisans may implement the described functionality in varying ways for each particular application, but such implementation should not be considered beyond the scope of the present disclosure.

In the several embodiments provided in the present disclosure, it should be understood that the disclosed systems, apparatus and methods can be implemented in other ways. For example, the apparatus embodiments described above are only illustrative. For example, the division of the modules is only a logical function division. In actual implementation, there may be other division methods. For example, multiple modules or components may be combined or may integrated into another system, or some features may be ignored or not executed. On the other hand, the coupling or direct coupling or communication connection between each other shown or discussed may be an indirect coupling or communication connection through some interface, apparatus or module, and may be electrical, mechanical or other forms.

Modules illustrated as separate components may or may not be physically separate, and components shown as modules may or may not be physical modules, i.e., may be located in one place or may also be distributed over multiple network elements. Some or all of the modules can be selected according to actual needs to achieve the purpose of the solution of this embodiment. For example, each functional module in various embodiments of the present disclosure can be integrated into one processing module, or each module can exist physically alone, or two or more modules can be integrated into one module.

In the embodiments of the present disclosure, the term “module” or “unit” refers to a computer program or a part of a computer program with a predetermined function, and works together with other relevant parts to achieve a predetermined goal, and can be achieved by using software, hardware (such as processing circuit or memory) or a combination thereof to be fully or partially implemented. Likewise, a processor (or multiple processors or memories) may be used to implement one or more modules or units. Furthermore, each module or unit may be part of an overall module or unit that contains the functionality of that module or unit.

The above are only specific implementation modes of the present disclosure, but the protection scope of the present disclosure is not limited thereto. Any person familiar with the technical field can easily think of changes or substitutions within the technical scope disclosed in the present disclosure. It should be covered by the protection scope of the present disclosure. Therefore, the protection scope of the present disclosure should be subject to the protection scope of the claims.

1. A frame rate adjustment method, applied to a terminal device, comprises:
in response to a trigger instruction for an object, obtaining an object type of the object, a resource file of the object, and/or a current power mode of the terminal device;
determining a target display frame rate of the object according to the object type of the object, the resource file of the object, and/or the current power mode of the terminal device; and
adjusting a current display frame rate of the object to a target display frame rate of the object according to a preset frame rate adjustment policy.

2. The method according to claim 1, further comprising:
when a current display frame rate after each adjustment is in an effective time, displaying a first image frame according to the current display frame rate after each adjustment, wherein the first image frame is a frame of image data in the resource file of the object.

3. The method according to claim 1, wherein the preset frame rate adjustment policy is to adjust the display frame rate in a manner of successive increment or successive decrement according to a preset frame rate interval.

4. The method according to claim 1, wherein the resource file of the object comprises at least two resource units, and a resource type of each resource unit is different; and
the determining the target display frame rate of the object according to the resource file of the object comprises:
determining a current resource unit of the object; and
determining the target display frame rate of the object according to the current resource unit of the object.

5. The method according to claim 4, wherein the determining the target display frame rate of the object according to the current resource unit of the object comprises:
obtaining the target display frame rate of the object from a mapping relationship between a resource unit and a display frame rate, according to the current resource unit of the object.

6. The method according to claim 1, wherein the determining a target display frame rate of the object according to the object type of the object, the resource file of the object, and/or the current power mode of the terminal device comprises:
obtaining the target display frame rate of the object from a mapping relationship among the object type and a display frame rate according to the object type of the object; or,
obtaining the target display frame rate of the object from a mapping relationship between a resource type and the display frame rate according to the resource file of the object; or,
obtaining the target display frame rate of the object from a mapping relationship between a power mode and the display frame rate according to the current power mode of the terminal device; or,
obtaining the target display frame rate of the object from a mapping relationship among the object type, the resource type, the power mode, and display frame rate, according to the object type of the object, the resource file of the object, and the current power mode of the terminal device.

7. The method according to claim 1, further comprising:
determining a number of other vertical synchronization signals to be generated when reaching a third image frame according to an image display duration of at least one second image frame, wherein a display time of the second image frame is earlier than a display time of the third image frame; and
determining a vertical synchronization signal time for the third image frame according to each other vertical synchronization signal time, the preset frame rate interval, a frame rate adjustment method and a display frame rate of the object in sequence, wherein the display frame rate of the object corresponds to each of the other vertical synchronization signals.

8. The method according to claim 7, further comprising:
determining a vertical synchronization signal time for the first image frame according to the vertical synchronization signal time for the third image frame;
determining an execution timestamp for an asynchronous time warp thread for the first image frame according to the vertical synchronization signal time for the first image frame; and
when it is determined that the execution timestamp of the asynchronous time warp thread for the first image frame is reached, executing the asynchronous time warp thread for the first image frame to warp the first image frame to obtain a new first image frame.

9. The method according to claim 8, wherein the determining an execution timestamp for an asynchronous time warp thread for the first image frame according to the vertical synchronization signal time for the first image frame comprises:
obtaining a first working duration of an asynchronous time warp thread for each second image frame and a second working duration of an asynchronous time warp thread for the third image frame;
determining an average value and a variance value of working durations according to the at least one first working duration and the second working duration;
determining a working duration of the asynchronous time warp thread for the first image frame according to the average value and the variance value of the working duration; and
determining the execution timestamp for the asynchronous time warp thread for the first image frame according to the vertical synchronization signal time for the first image frame and the working duration of the asynchronous time warp thread for the first image frame.

10. The method according to claim 8, further comprising:
determining an execution timestamp of a target interface according to the vertical synchronization signal time for the first image frame and a preset time interval; and
when it is determined that the execution timestamp of the target interface is reached, controlling the target interface to transmit the new first image frame to a screen of the terminal device for a display operation.

11. The method according to claim 8, further comprising:
determining a predicted display duration of the object according to the display frame rate of the object and an expected display frame rate of the object, wherein the display frame rate is the current display frame rate or a current display frame rate after each adjustment;
determining an execution timestamp of a target pulse modulation signal for lighting a screen according to the predicted display duration of the object; and
when the execution timestamp of the target pulse modulation signal is reached, lighting screen backlight according to the target pulse modulation signal, and displaying the new first image frame through the screen.

12. An electronic device, comprising:
a processor and a memory, wherein the memory is configured to store a computer program, the processor is configured to invoke and run the computer program stored in the memory to perform a frame rate adjustment method, and the method comprises:
in response to a trigger instruction for an object, obtaining an object type of the object, a resource file of the object, and/or a current power mode of the terminal device;
determining a target display frame rate of the object according to the object type of the object, the resource file of the object, and/or the current power mode of the terminal device; and
adjusting a current display frame rate of the object to a target display frame rate of the object according to a preset frame rate adjustment policy.

13. The electronic device according to claim 12, wherein the method further comprises:
when a current display frame rate after each adjustment is in an effective time, displaying a first image frame according to the current display frame rate after each adjustment, wherein the first image frame is a frame of image data in the resource file of the object.

14. The electronic device according to claim 12, wherein the preset frame rate adjustment policy is to adjust the display frame rate in a manner of successive increment or successive decrement according to a preset frame rate interval.

15. The electronic device according to claim 12, wherein the resource file of the object comprises at least two resource units, and a resource type of each resource unit is different; and
the determining the target display frame rate of the object according to the resource file of the object comprises:
determining a current resource unit of the object; and
determining the target display frame rate of the object according to the current resource unit of the object.

16. The electronic device according to claim 15, wherein the determining the target display frame rate of the object according to the current resource unit of the object comprises:
obtaining the target display frame rate of the object from a mapping relationship between a resource unit and a display frame rate, according to the current resource unit of the object.

17. The electronic device according to claim 12, wherein the determining a target display frame rate of the object according to the object type of the object, the resource file of the object, and/or the current power mode of the terminal device comprises:
obtaining the target display frame rate of the object from a mapping relationship among the object type and a display frame rate according to the object type of the object; or,
obtaining the target display frame rate of the object from a mapping relationship between a resource type and the display frame rate according to the resource file of the object; or,
obtaining the target display frame rate of the object from a mapping relationship between a power mode and the display frame rate according to the current power mode of the terminal device; or,
obtaining the target display frame rate of the object from a mapping relationship among the object type, the resource type, the power mode, and display frame rate, according to the object type of the object, the resource file of the object, and the current power mode of the terminal device.

18. The electronic device according to claim 12, wherein the method further comprises:
determining a number of other vertical synchronization signals to be generated when reaching a third image frame according to an image display duration of at least one second image frame, wherein a display time of the second image frame is earlier than a display time of the third image frame; and
determining a vertical synchronization signal time for the third image frame according to each other vertical synchronization signal time, the preset frame rate interval, a frame rate adjustment method and a display frame rate of the object in sequence, wherein the display frame rate of the object corresponds to each of the other vertical synchronization signals.

19. The electronic device according to claim 18, wherein the method further comprises:
determining a vertical synchronization signal time for the first image frame according to the vertical synchronization signal time for the third image frame;
determining an execution timestamp for an asynchronous time warp thread for the first image frame according to the vertical synchronization signal time for the first image frame; and
when it is determined that the execution timestamp of the asynchronous time warp thread for the first image frame is reached, executing the asynchronous time warp thread for the first image frame to warp the first image frame to obtain a new first image frame.

20. A non-transitory computer-readable storage medium, configured to store a computer program, wherein the computer program causes a computer to execute a frame rate adjustment method, and the method comprises:
in response to a trigger instruction for an object, obtaining an object type of the object, a resource file of the object, and/or a current power mode of the terminal device;
determining a target display frame rate of the object according to the object type of the object, the resource file of the object, and/or the current power mode of the terminal device; and
adjusting a current display frame rate of the object to a target display frame rate of the object according to a preset frame rate adjustment policy.
